(19) United States
(12) Patent Application Publication
(10) Pub. No.: US 2008/0157616 A1
(43) Pub. Date: Jul. 3, 2008

(54) Electric Motor

(76) Inventors: Michael Bulatow, Berlin (DE); Andre Gornott, Berlin (DE)

Correspondence Address: FASSE PATENT ATTORNEYS, P.A., P.O. BOX 726, HAMPDEN, ME, 04444-0726, US

(21) Appl. No.: 11/885,215

(22) PCT Filed: Feb. 24, 2006
(86) PCT No.: PCT/DE06/00392

§ 371 Date: Aug. 27, 2007

(30) Foreign Application Priority Data
Feb. 28, 2005 (DE) 10 2005 009 599.2
Sep. 28, 2005 (DE) 10 2005 046 284.7

(51) Int. Cl. H02K 5/16; H02K 15/00

(52) U.S. Cl. 310/90; 310/216; 29/596; 264/328.1

(57) ABSTRACT

The invention relates to an electric motor with a rotor that comprises a rotor shaft and a rotor body, and a stator that comprises a stator lamination packet with a plurality of stator laminations and at least one integrated bearing seat for receiving a bearing, in which the rotor shaft is rotatably supported, whereby at least one endface stator lamination of the stator lamination packet comprises means for reinforcing the bearing seat.

The invention relates to an electric motor with a rotor, that comprises a rotor shaft and a rotor body, and a stator that comprises a stator metal sheet or lamination packet with a plurality of stator laminations and at least one integrated bearing seat for receiving a bearing, in which the rotor shaft is rotatably supported, as well as methods for assembling such an electric motor.

The invention is especially suited, for example, for the application in motor vehicles. In the motor vehicle field, electric motors, which are embodied as small motors, play a significant role due to the limited construction or installation space. Small motors are electric motors with small dimensions and generally have a power up to 1 kW.

Electric motors can be embodied as internal rotor motors or external rotor motors. Internal rotor motors comprise a fixed or stationary stator and an internal rotating rotor. The rotor is coaxially concentrically inserted in the stator. In an external rotor motor, the rotor concentrically surrounds the stator. Furthermore, electric motors typically comprise a housing that protects the motor against external influences, such as, for example, dirt or moisture. Moreover, the rotor or the rotor shaft must be rotatably supported by means of bearings. The bearing support of the rotor shaft is, for example, realized with one or more complicated bearing plates or brackets. In that regard, one or more separate bearing plates or brackets must be produced corresponding to the respective motor external contour, since there are a plurality of variants with respect to the rotor bearing support arrangement and the corresponding receiver geometries in the bearing plate or bracket. However, there also exists the possibility, that the stator comprises integrated bearing seats for receiving bearings in which the rotor shaft is rotatably supported.

An electric machine with a rotor bearing support arrangement integrated in the stator is known from the DE 103 12 614 A1. The rotor shaft is rotatably supported in roller bearings and the roller bearings are received by bearing rings that are arranged in the stator of the electric machine.

A brush-less direct current motor is known from the DE 40 21 599 A1, whereby the motor has a shaft, a permanent magnetic rotor and a stator with several pole shoes or pieces that are provided with windings, whereby two shells of non-magnetic material are provided, which respectively comprise a bearing for the shaft and mountings for the pole shoes or pieces.

The underlying object of the invention is to further develop an electric motor of the initially mentioned type in such a manner so that it is compact and as small-constructed as possible. Furthermore, it shall be produced in a simple and economical or cost-advantageous manner.

This object is achieved by the characterizing features of the patent claims 1, 6 and 8. Advantageous further developments can be seen from the dependent claims.

The electric motor has a rotor that comprises a rotor shaft and a rotor body, and a stator that comprises a stator metal sheet or lamination packet with a plurality of stator laminations and at least one integrated bearing seat for receiving a bearing, in which the rotor shaft is rotatably supported.

Since the bearing is loaded by various forces, it is sensible to reinforce or strengthen the bearing seat. For that purpose, at least one stator lamination on the endface of the stator lamination packet is embodied in such a manner that it comprises means for reinforcing or strengthening the bearing seat.

Advantageously the means for reinforcing are embodied as reinforcing cores or armatures and are arranged on the inner diameter of the endface stator lamination.

In an advantageous manner, the reinforcing cores or armatures and the endface stator lamination are embodied in a one-piece manner. Especially the stator laminations of the stator lamination packet comprise a lacquer layer, for example a baked or cured lacquer layer, on at least one side, and are connected or bonded with one another in a material fixing or joining manner by a chemical-thermal bond. The coated stator laminations are first joined together to form a so-called stator lamination packet. Thereupon the stator lamination packet is briefly heated, whereby the lacquer coating layer, especially the baked or cured lacquer coating layer, is caused to melt and thus chemically-thermally bonds the stator laminations rigidly or tightly with one another.

In order to be able to provide the stator lamination packet with windings, the stator lamination packet, especially the pole teeth of the stator lamination packet, must be electrically insulated. For that purpose, the stator lamination packet is surrounded or encased by injection molding with a synthetic plastic. The bearing seat on the stator is formed during the injection molding encasement of the stator lamination packet.

Particularly, before the injection molding encasement of the stator lamination packet and the injection or spraying of the bearing seat, the reinforcing cores or armatures are bent or angled, and particularly in that direction in which the injected or sprayed bearing seat is located. Essentially, the reinforcement cores or armatures are bent or angled by 90°. After fabrication of the bearing seat, the bearing is pressed into the bearing seat.

Alternatively, the bearing can be inserted or laid into an injection tool or mold, and the bearing seat is “injection molded around” the bearing in the injection tool or mold practically during the injection molding encasement of the stator lamination packet.

Further features and details of the invention will be explained more closely in connection with the accompanying drawings on the basis of example embodiments, in the following description. In that regard, features and interrelationships described in individual variants are basically transferable to all example embodiments. In the drawings:

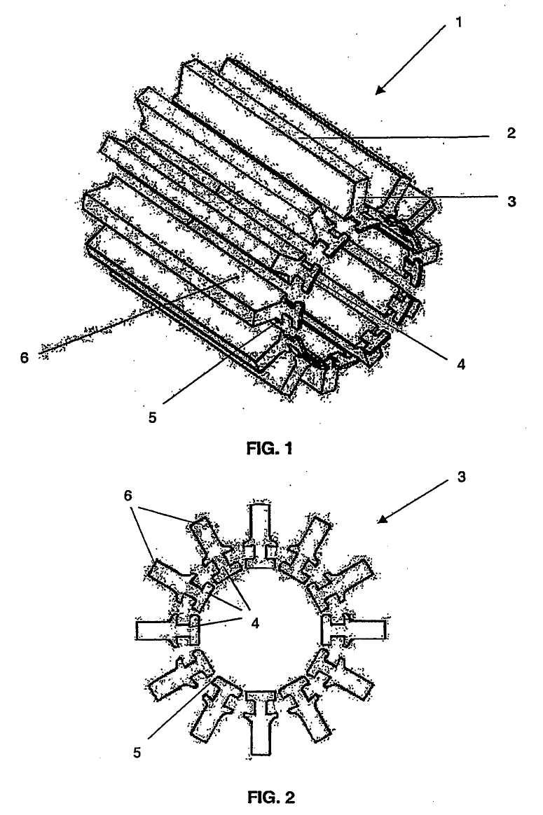

FIG. 1 shows an embodiment of the stator of the electric motor according to the invention in a perspective view;

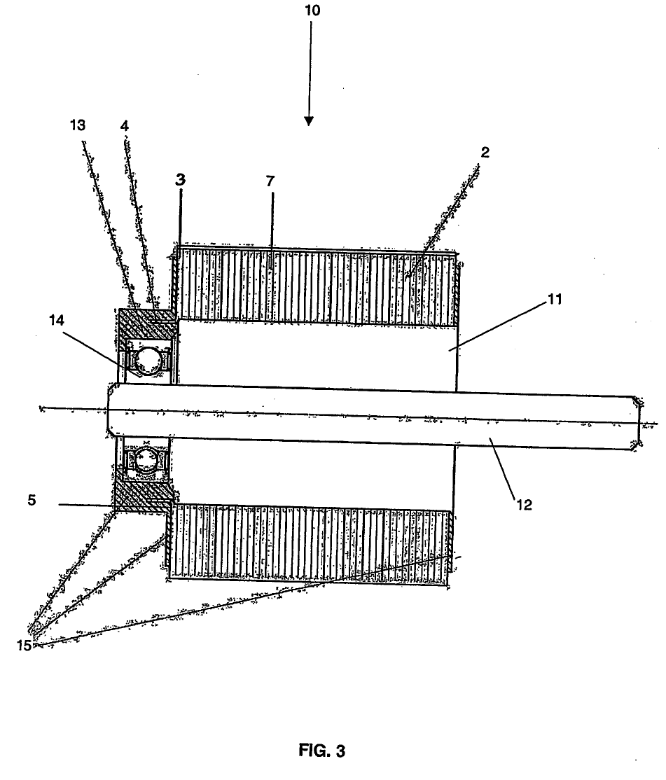

FIG. 2 shows an embodiment of the endface stator lamination of the electric motor according to the invention in a top plan view;

FIG. 3 shows a partial view of an electric motor according to the invention in a longitudinal sectional view.

FIG. 1 shows an embodiment of a stator of the electric motor according to the invention in a perspective view. The stator 1 consists of a stator lamination packet 2 with a plurality of stator metal sheets or laminations. The stator lamination 3 on the endface of the stator lamination packet 2 is embodied in such a manner that it comprises means for strengthening or reinforcing the bearing seat which is not shown. The means for reinforcing are embodied as reinforcing cores or armatures 4 and are arranged on the inner diameter 5 of the endface stator lamination 3. The reinforcing cores 4 and the endface stator lamination 3 are embodied in a one-piece manner. It can be seen especially well that the reinforcing cores 4 are angled or bent before the injection molding encasement of the stator lamination packet 2, and particularly in that direction in which the injection molded bearing seat, which is not shown, will later be located. Essentially, the reinforcing cores 4 are bent or angled by 90°. Furthermore, the pole teeth or spokes 6 of the stator lamination packet 2, which are provided with windings that are not shown, can be recognized.

FIG. 2 shows an embodiment of the endface stator lamination of the electric motor according to the invention in a top plan view. The endface stator lamination 3 comprises the reinforcing cores or armatures 4 for reinforcing the bearing seat that is not shown. The reinforcing cores 4 are arranged on the inner diameter 5 of the endface stator lamination 3. It can be recognized especially well, that the reinforcing cores 4 and the endface stator lamination 3 are embodied in a one-piece manner. In FIG. 2, the reinforcing cores are not bent or angled. Furthermore, the pole teeth or spokes 6 of the stator lamination packet 2, which are provided with windings that are not shown, can be recognized.

FIG. 3 shows a partial view of an electric motor according to the invention in a longitudinal sectional illustration. The electric motor 10 has a rotor that comprises a rotor shaft 12 and a rotor body 11, and a stator that comprises a stator lamination packet 2 with a plurality of stator laminations 7 and an integrated bearing seat 13 for receiving the bearing 14, in which the rotor shaft 12 is rotatably supported.

Since the bearing 14 is loaded by various forces, it is sensible to reinforce the bearing seat 13. For that purpose, the endface stator lamination 3 comprises means for reinforcing or strengthening the bearing seat 13. The reinforcing means are embodied as reinforcing cores or armatures 4 and are arranged on the inner diameter 5 of the endface stator lamination 3.

The stator laminations 7 comprise, at least on one side, a lacquer coating layer that is not shown, and are connected or bonded with one another in a material fixed or joining manner by a chemical-thermal bond.

In order to be able to provide the stator lamination packet 2 with windings that are not shown, the stator lamination packet 2, especially the not-visible pole teeth or spokes 6, must be electrically insulated. For that purpose, the stator lamination packet 2 is preferably encased by injection molding with synthetic plastic, whereby the injection molded casing or housing 15 is formed. The bearing seat 13 is formed during the injection molding process of the stator lamination packet 2. Before the injection molding encasement of the stator lamination packet 2 and the injection or spraying of the bearing seat 13, the reinforcing cores or armatures 4 are bent or angled, and particularly in that direction in which the injected bearing seat 13 is located. Essentially, the reinforcing cores or armatures 4 are bent or angled by 90°. After fabrication of the bearing seat 13, the bearing 14 is pressed into the bearing seat 13.

### REFERENCE NUMBER LIST

1 stator
2 stator lamination packet
3 endface stator lamination
4 reinforcing core or armature
5 inner diameter of the stator lamination 3
6 pole teeth or spokes
7 stator laminations
10 electric motor
11 rotor body
12 rotor shaft
13 bearing seat
14 bearing
15 injection molded casing or housing

1. Electric motor (10) with a rotor that comprises a rotor shaft (12) and a rotor body (11), and a stator that comprises a stator lamination packet (2) with a plurality of stator laminations (3, 7) and at least one integrated bearing se at (13) for receiving a bearing (14) in which the rotor shaft (12) is rotatably supported, characterized in that least one endface stator lamination (3) of the stator lamination packet (2) comprises means for reinforcing the bearing seat (13).

2. Electric motor (10) according to claim 1, characterized in that the means for reinforcing are embodied as reinforcing cores (4).

3. Electric motor (10) according to claim 2, characterized in that the reinforcing cores (4) are arranged on the inner diameter (5) of the endface stator lamination (3).

4-5. (canceled)

6. Method for assembling an electric motor (10) according to claim 1, characterized in that the stator lamination packet (2) is encased by injection molding with synthetic plastic for electrical insulation, and the bearing seat (13) is formed on the stator during the injection molding encasement of the stator lamination packet (2).

7. Method according to claim 6, characterized in that the bearing (14) is pressed into the bearing seat (13) after fabrication of the bearing seat (13).

8. Method for assembly of an electric motor (10) according to claim 1, characterized in that the stator lamination packet (2) is encased by injection molding with synthetic plastic for electrical insulation, and the bearing (14) is inserted into an injection molding tool and the bearing seat (13) is formed on the stator during the injection molding encasement of the stator lamination packet (2).

9. Electric motor (10) according to claim 2, characterized in that the reinforcing core (4) and the endface stator lamination (3) are embodied in a one-piece manner.

10. Electric motor (10) according to claim 1, characterized in that the stator laminations (3, 7) comprise a lacquer coating layer at least on one side, and are connected with one another in a material joining manner by a chemical-thermal bond.
